(19) United States
(12) Patent Application Publication
(10) Pub. No.: US 2008/0162166 A1
(43) Pub. Date: Jul. 3, 2008

(54) System for simply and directly providing local information based solely on zip code information

(76) Inventors: Sandra Naroian, Bolton, MA (US); Gregory K. Afarian, North Andover, MA (US); James A. Shiner, North Reading, MA (US)

Correspondence Address: Russ Weinzimmer, 614 Nashua Street #204, Milford, NH, 03055, US

(21) Appl. No.: 11/648,067

(22) Filed: Dec. 30, 2006

(51) Int. Cl. G06Q 50/00

(52) U.S. Cl. 705/1

(57) ABSTRACT

A web-based user interface and method for providing home and community information, move-in and move-out information, as well as vendor information in a simple and easy-to-access format for real estate professionals, future homeowners, and current homeowners. The user interface accepts only a zip code or town and city location information on a first web page, and then displays home and community information, move-in and move-out information, and/or vendor information in response to the location information submitted. A very simple user interface thereby provides a large collection of locally targeted information without the tedium and frustrations of previous methods. Such targeted information can facilitate a home sale, or a ease a move-in or move-out. The vendor information includes ratings and reviews of local vendors submitted by actual customers that may help a homeowner in making a more informed and therefore better decision about which vendor to select for products and/or services.

### FIELD OF THE INVENTION

The present invention is directed to interactive websites, and more particularly to an informative and interactive website for facilitating real estate sales and property ownership.

### BACKGROUND OF THE INVENTION

Millions of Americans buy or sell a home each year. While purchasing a new home can be an exciting and exhilarating experience, it can also be a stressful and difficult process due to the wide reaching consequences of such an important decision. As such, most future homeowners strive to gather as much information as possible about the prospective home and its community in order to make an informed decision. This information can include town and school statistics, sex offender registries, town hall records, board of health records, and any other information that may aid a future or current homeowner. Also, to assist and facilitate home sales, realtors or other real estate professionals often must gather and present to a prospective buyer an extensive amount of information regarding the home and its surroundings.

After completion of the sale, the new homeowner is faced with the task of quickly hooking up telephone, gas, electric, cable and other basic utility services to ensure a smooth move-in. Likewise, a homeowner who has recently sold his or her home is faced with the task of disconnecting these same utilities to ensure a smooth move-out.

To facilitate both the purchase/sale decision as well as the move-in/move-out process, the parties involved often need to gather a large amount of locally specific information. This information, however, is usually not found in one place, and can be time consuming and frustrating to locate. Several resources have been created to assist future, current and previous homeowners in finding this information. These resources, however, are inadequate for a variety of reasons.

One such resource, in use for many years, is the paper telephone book. While the telephone book certainly provides the contact information for any one business, school, or government entity in the area, a homeowner or real estate professional is faced with the time-consuming task of flipping back and forth between the pages, pouring over small print to find the correct local phone numbers or addresses for these entities. Furthermore, as most telephone books are only updated annually or semi-annually, the homeowner or real estate professional has no assurance that the information contained in the telephone book is still correct. Also, the homeowner just moving in may not yet have a telephone book, and would need to go to a public pay phone or would need to borrow one from a neighbor.

With the advent of the world-wide-web, the information contained in the telephone book has been made more accessible to future, current and previous homeowners, as well as to real estate professionals, in electronic form. Although more accessible, this resource still is subject to some of the same weaknesses attributed to its paper counterpart. A homeowner must still browse many business, school, and government listings on many web pages to find the addresses and phone numbers of each entity. Additionally, these resources may not provide a hyperlink to the entities website, requiring the homeowner to call or visit each entity to retrieve additional information, if needed.

In addition, homeowners who have neither recently purchased nor recently sold a home still pass through periods of stress or difficulty related to home ownership. One such scenario occurs when a crucial system in the house, such as the heater, breaks. In this scenario the homeowner needs to quickly find and contact a vendor to fix the problem. The telephone book or yellow pages, whether in the paper or on-line version, is usually the first place that most homeowners turn to find a vendor in a hurry. These listings do little, however, to help a homeowner know which of all the vendors is able, trustworthy, and cost efficient. Thus, many homeowners rely on the ads in the telephone book, resulting in sometimes inept or very expensive service.

### SUMMARY OF INVENTION

In one general aspect, the invention is a method for facilitating access to local move-in information and move-out information by real estate professionals and homeowners. The method includes the steps of: providing an internet-accessible website having a home webpage and a second webpage; requesting only location information on the home webpage; and displaying on the second webpage move-in and move-out information which is specific to the location information.

In preferred embodiments, the location information is a zip code. In other preferred embodiments, the location information is a town and a state.

In some preferred embodiments, the move-in and move-out information includes at least one of a phone number and a website address of a local utility. In other preferred embodiments, the move-in and move-out information includes at least one of a phone number and a website address of each of a plurality of local utilities. In further preferred embodiments, the move-in and move-out information of the plurality of local utilities is grouped together on a first portion of the second webpage.

In some embodiments, the invention also further includes displaying on the second webpage helpful contact information which is specific to the location information, the helpful contact information including contact information for at least one of: Fire, Police, Board of Health, Building Inspector, Registry of Deeds, Assessors Office. In further preferred embodiments, the helpful contact information is grouped together on a second portion of the second webpage.

In some embodiments, the invention also further includes displaying on the second webpage a list of vendor categories, each vendor category being associated with a link to at least one vendor in the vendor category, the at least one vendor being associated with the location information. In further preferred embodiments, the at least one vendor is assigned a rating.

Another general aspect of the invention is a web-based user interface for facilitating access to move-in and move-out information by real estate professionals and homeowners The user interface includes: a location input module on a home page of a website, the location input module allowing a user to submit only location information on the home page; and a move-in and move-out information display module on a second page of the website, the information display module displaying move-in information and move-out information which is associated with the location information.

In preferred embodiments, the location information is a zip code. In other preferred embodiments, the location information is a town and a state.

In some embodiments, the invention also further includes a vendor information display module on the second page of the website, the vendor information display module displaying a list of vendor categories, each vendor category being associated with a link to at least one vendor in the vendor category, the at least one vendor being associated with the location information.

Another general aspect of the invention is a web-based user interface for facilitating access to vendor information by real estate professionals and homeowners. The user interface includes: a location input module on a home page of a website, the location input module allowing a user to submit only location information on the home page; and a vendor information display module on a second page of the website, the information display module displaying vendor information which is associated with the location information.

In some embodiments, the invention also further includes: home and community information specific to the location information.

Another general aspect of the invention is a method for facilitating access to local vendor information by real estate professionals and homeowners. The method includes: providing an internet-accessible website having a home webpage and a second webpage; requesting only location information on the home webpage; and displaying on the second webpage links to vendor information which is specific to the location information.

In preferred embodiments, the links to vendor information are grouped together on a first portion of the second webpage.

In other preferred embodiments, each link to vendor information is associated with a vendor category.

In yet other preferred embodiments, the links to vendor information includes links to vendor rating information.

The present invention solves the problem of providing home and community information, move-in and move-out information, as well as vendor information in a simple and easy-to-access format for future and current homeowners over the internet. By only asking for location information on a first web page and then displaying home and community information, move-in and move-out information and/or vendor information in response to the location information submitted, a homeowner is provided a very simple user interface that provides targeted information without the time and frustrations of previous methods. Such targeted information may help facilitate a home sale, or a smooth move-in or move-out. Additionally, the vendor information may include ratings and reviews of local and regional vendors submitted by actual customers that may help a homeowner in making a more informed decision about which vendor to select for products or services.

### BRIEF DESCRIPTION OF THE DRAWINGS

The invention will be more fully understood by reference to the detailed description, in conjunction with the following figures, wherein:

FIG. 1A is a flow chart showing one embodiment of a method for providing homeowners with easy access to move-in information and move-out information via the internet;

FIG. 1B is a flow chart showing a user's experience of the method of FIG. 1A;

FIG. 2A is a flow chart showing one embodiment of a method for providing homeowners with easy access to vendor information via the internet;

FIG. 2B is a flow chart showing a user's experience of the method of FIG. 2A;

FIG. 3 is an illustration of a homepage allowing input of location information using a zip code input field;

FIG. 4 is an illustration of a homepage allowing input of location information using a town input field;

FIG. 5 is an illustration of a homepage allowing input of location information using a state input menu, thereby enabling finding a zip code within the selected state;

FIG. 6 is an illustration of a second webpage presented in accordance with the location information provided using the homepage, the second webpage including home and community information, move-in/move-out information, and a vendor category list display module;

FIG. 7 is an illustration of a vendor category module of the vendor category list display module of FIG. 6, the vendor category module having three vendors;

FIG. 8 is an illustration of a vendor profile “About” tab of a local vendor module corresponding to a vendor shown in FIG. 7;

FIG. 9 is an illustration of a vendor profile “Review” tab of a local vendor module corresponding to a vendor shown in FIG. 7;

FIG. 10 is an illustration of a vendor profile “Photos/Video” tab of a local vendor module corresponding to a vendor shown in FIG. 7;

FIG. 11 is a view of one embodiment of the text me tab included on one embodiment of the local vendor module;

FIG. 12A is a flow chart showing one embodiment of a method for providing homeowners with easy access via the internet to home and community information for facilitating a home sale or purchase; and

FIG. 12B is a flow chart showing a user's experience of the method of FIG. 12A.

### DETAILED DESCRIPTION

A method and a user interface is provided for helping homeowners, home buyers, home sellers, and the agents of home buyers and sellers, to gain easy access, via the web, to home and community information, move-in and move-out information, as well as to vendor information and associated ratings, during each stage of home ownership.

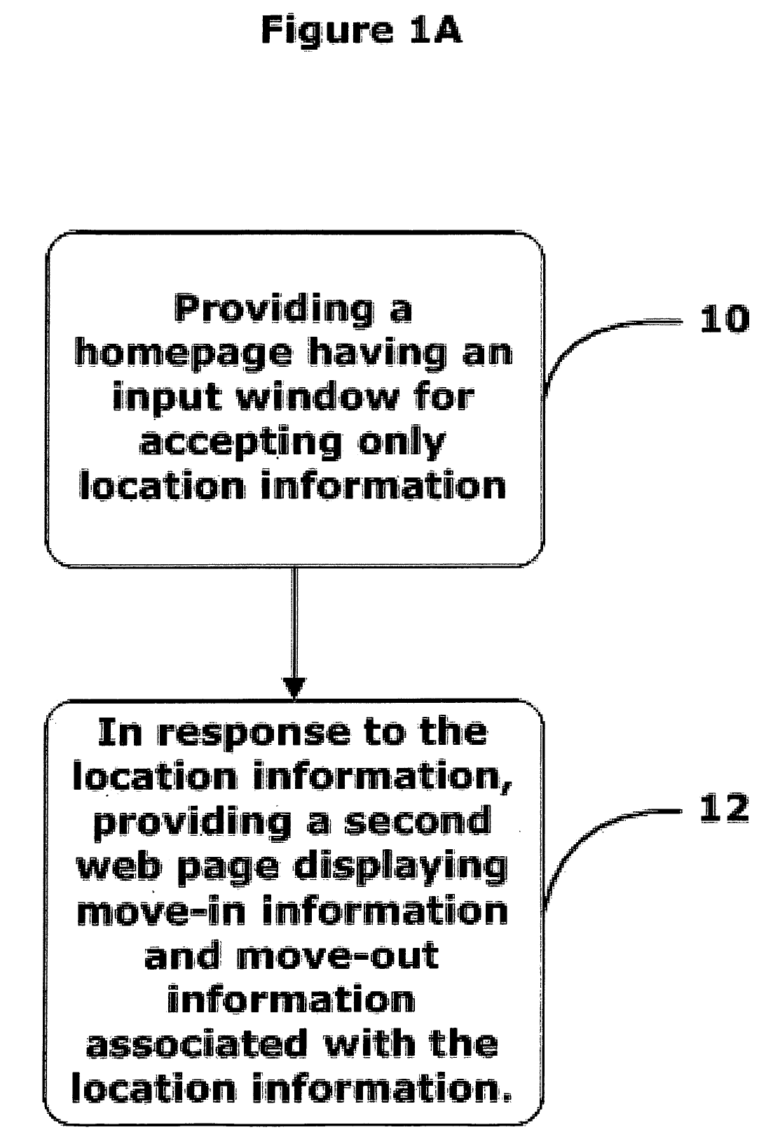

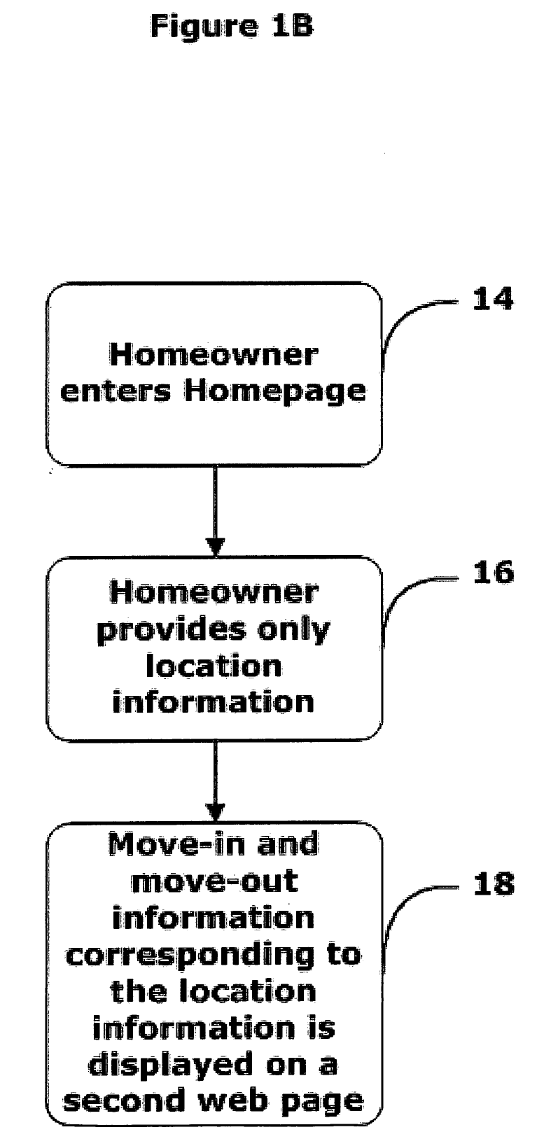

With reference to FIG. 1A, one aspect of the invention enables a user to easily access move-in and move-out information over the internet. The invention provides a homepage having an input window for accepting only location information 10, such as only a “zip code”. There is no input field for accepting street information. A full address is NOT required, nor allowed. Apartment numbers and/or unit numbers are also not required or allowed. In response to the location information, the invention provides a second web page displaying at least move-in and move-out information that is associated with the location information 12. The move-in and move-out information can include the phone numbers, links to web pages, email addresses, and postal addresses of the electric company, the gas company, the phone company, and the cable company, for either starting or ending service with each company.

With reference to FIG. 1B, a user enters website 14 by using their web browser to visit a URL associated with the website, such as www.dailyhomeowner.com. Upon entering the website, the user can submit only location information 16 because the homepage of the website does not allow or require any other information. During this step 16, the homeowner can enter the location information as a zip code alone, or as a state and one of a town and a city, without requesting or requiring zip code information. Alternatively, the user can look up a zip code by selecting a state and then a town, which consequently provides zip codes associated with the town. A zip code can then be entered as location information, and can also be used to correspond with vendors, home and community information, etc.

Once the user has submitted the location information, all of the move-in and move-out information is displayed on a single second web page 18. The move-in and move-out information includes the contact information of utility companies servicing a location associated with the location information. This contact information can be in the form of a telephone number, an email address, a web page, or a postal address. Typically, there is at least a phone number and/or a link to a website.

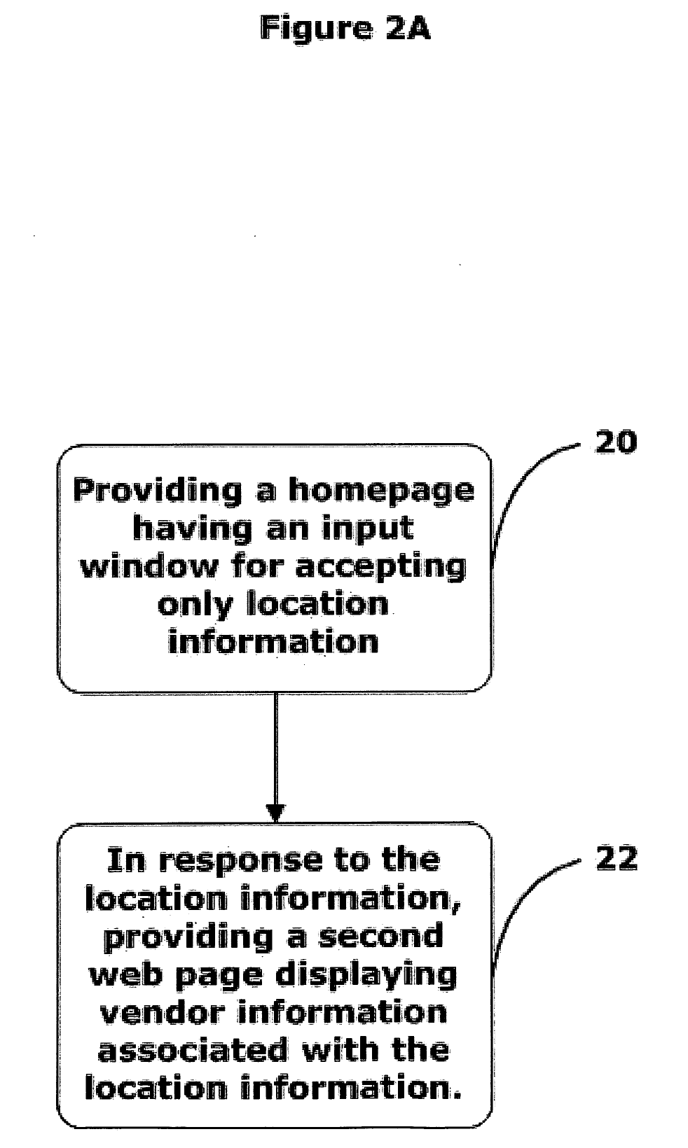

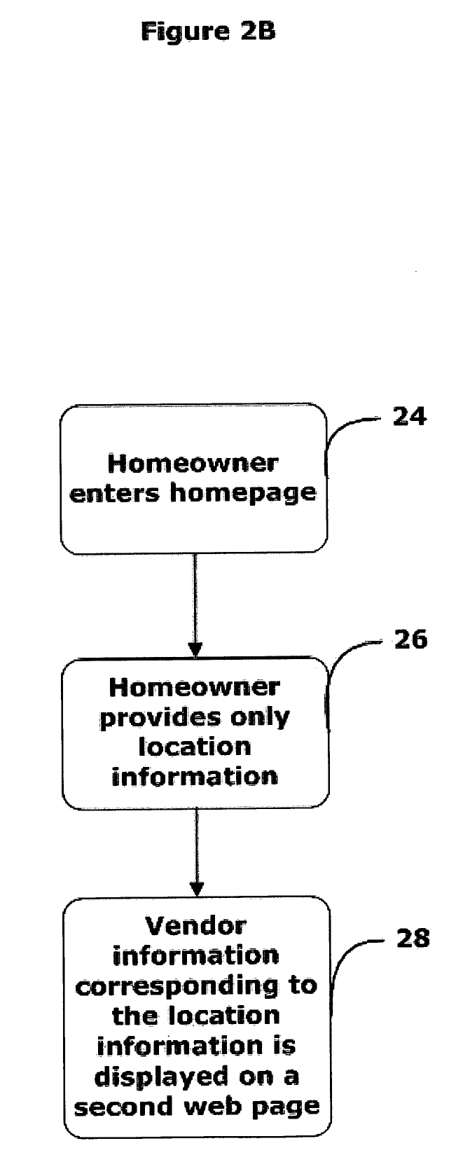

As illustrated in FIG. 2A, another aspect of the invention includes providing a homepage having an input window for accepting only location information 20, such as only a zip code, and then in response to the location information, providing a second web page displaying a collection of local vendor information associated with the location information. The vendor information appears on the same page as the move-in/move-out information of FIG. 1A.

To access local vendor information, a user can easily access it via the web by taking a few similar short and easy steps, such as clicking on a sequence of one, two, or three links. First, the homeowner will enter the website 24 by pointing his or her web browser to a URL, such as www.dailyhomeowner.com, for example. Upon entering the website, the homeowner can again only submit location information 26 in the form of a zip code, or a state and one of a city and town. Street information is neither required or permitted to be input into the home page user interface.

Optionally, the homeowner is offered the option of searching for a zip code by choosing a state and then a town, for which a zip code associated with the town is then displayed. A map of the state may be displayed with all or some of the towns marked on the map. A list of towns and associated zip codes may also be displayed from which a user may select one specific zip code from which to view vendor information. This particular search tool can be especially helpful for those homeowners which have recently moved into a new area.

After submitting the location information, vendor information is selected based on the location information so as to provide local vendor information, and that local vendor information is displayed 28 on a web page in response to the user pressing the “Enter” key after entering the location information (e.g., the zip code). The vendor information is displayed in the form of an alphabetized list of the names of local vendors whose physical address is within or in close proximity to the zip code or town submitted in step 26.

Vendor information can also be organized and displayed as vendor categories. Vendor information can include vendor contact information, such as phone numbers, postal addresses, web pages, and email addresses. Vendor information can contain ratings (such as “Five Star” ratings) and reviews of vendor's products and services by actual customers, advertisements from the vendors, and a profile of the vendor and its services and/or products. All of the vendor information need not be displayed on this second web page. There can be links on the second web page that direct the user to another webpage with additional vendor information or to the vendor's own website. Such additional information can include streaming video, downloadable video. The links on the second page can link directly to streaming or downloadable video, such as “video walkthroughs”, vendor commercials, instructional videos, etc.

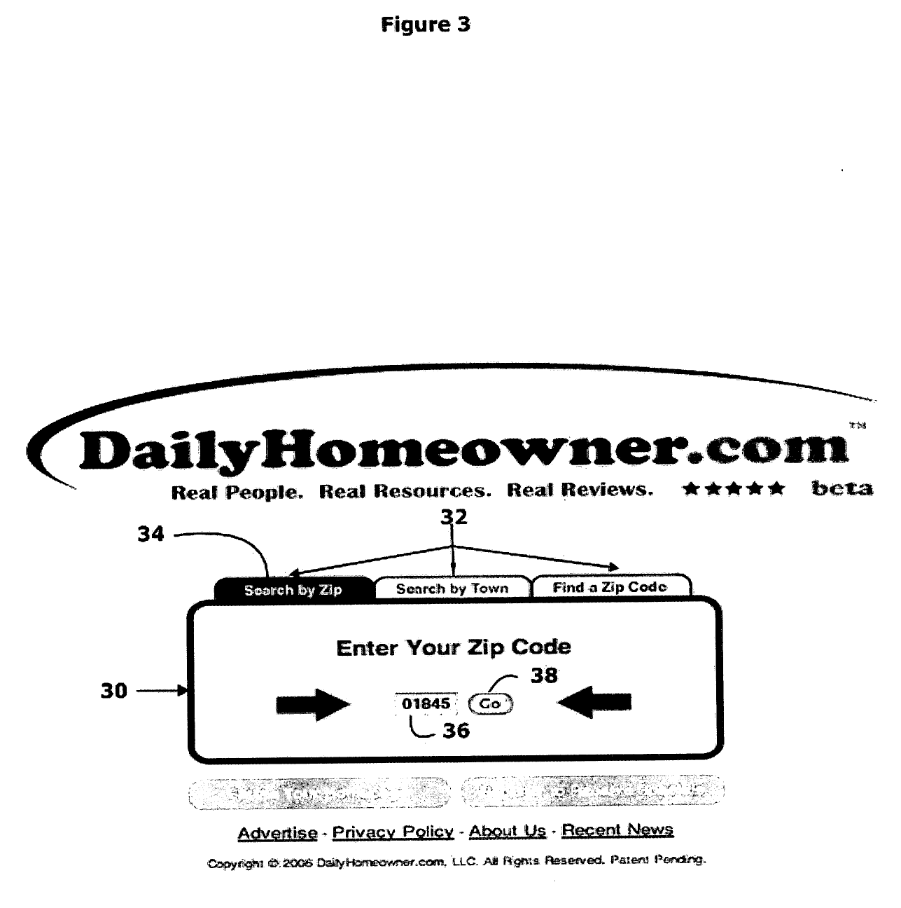

With reference to FIG. 3, an important aspect of the present invention is a simple and easy-to-use homepage user interface. To provide simplicity and ease of use, the homepage user interface accepts only location information for every location within the United States. Location information can take many forms, such as ZIP Code, town, city, and state. Location information does NOT include street addresses, suite or unit numbers. Zip code information is preferred, if that is known. Accordingly, a location input module 30 is provided to request and receive location information in a variety of forms. To enhance the ease-of-use of the location input module 30, input field tabs 32 are provided. The input field tabs 32 allow a user to easily toggle between different input fields. This has the advantage of avoiding the undue clutter and complexity that would be evident if all input fields were displayed at once on the location input module 30.

In another embodiment of the present invention, all input fields can be displayed together on the location input module 30. Alternatively, the various input fields can appear as hyperlinks that direct the homeowner to a different section of the same page, or to a second page. Further the location input module 30 can present the homeowner with a pop-up window in which to enter the location information.

In one embodiment of the present invention, the location input module 30 includes a zip code tab 34, which includes a zip code input field 36 into which a homeowner may enter a zip code, and then click on a go button 38. Clicking on the go button 38 corresponds to step 16 of FIG. 1B, and results in a second page appearing which includes move-in and move-out information, and also includes vendor information, or links to vendor information.

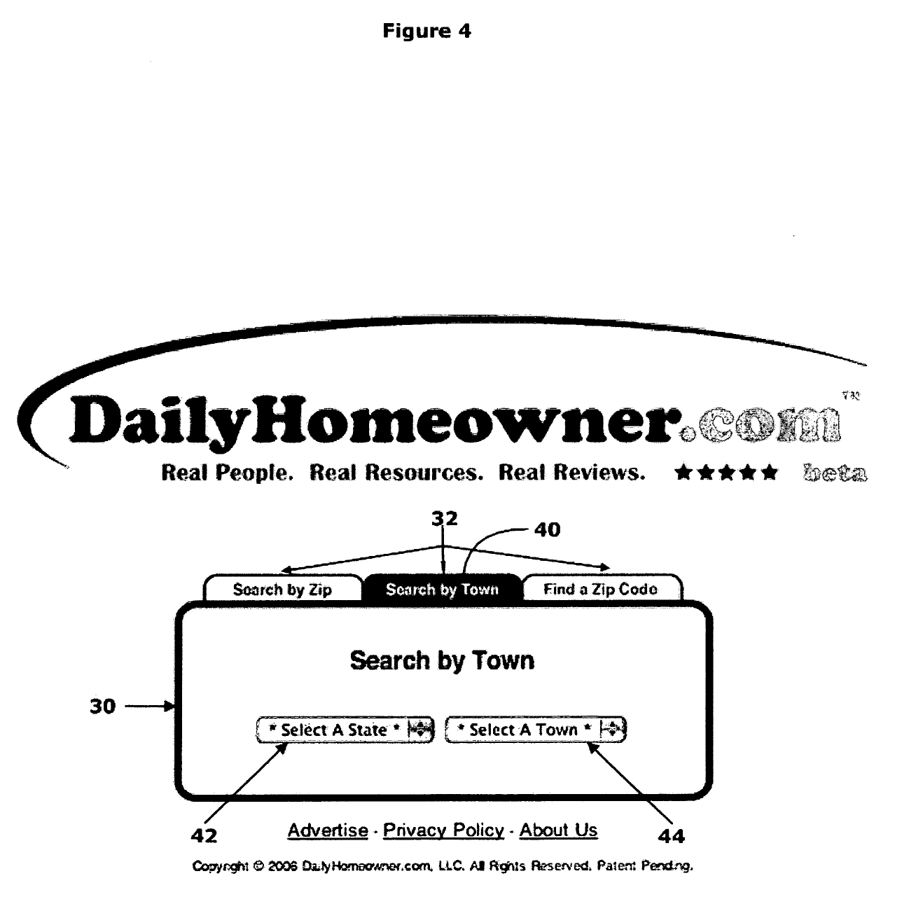

As illustrated in FIG. 4, a user can also select the “Search by Town” tab 40, from among the tabs 32 of the location input module 30, to submit location information. The town tab 40 presents a state selector 42 and a town selector 44. Both the state selector 42 and town selector 44 are drop-down menus which displays a list of states, and subsequently a list of towns within the selected state from the list of states. A user may then select a town from the list of towns displayed in the drop down menu of the town selector 44. Once both the state and town are selected, the second page having associated local move-in and move-out information and/or vendor information automatically appears.

Alternatively, the town tab 40 can present a plurality of input fields that can be populated by the homeowner with a state name, either abbreviated or non-abbreviated, and a town name. The populated state and town input fields automatically cause the second page having corresponding move-in and move-out information and/or vendor information to appear.

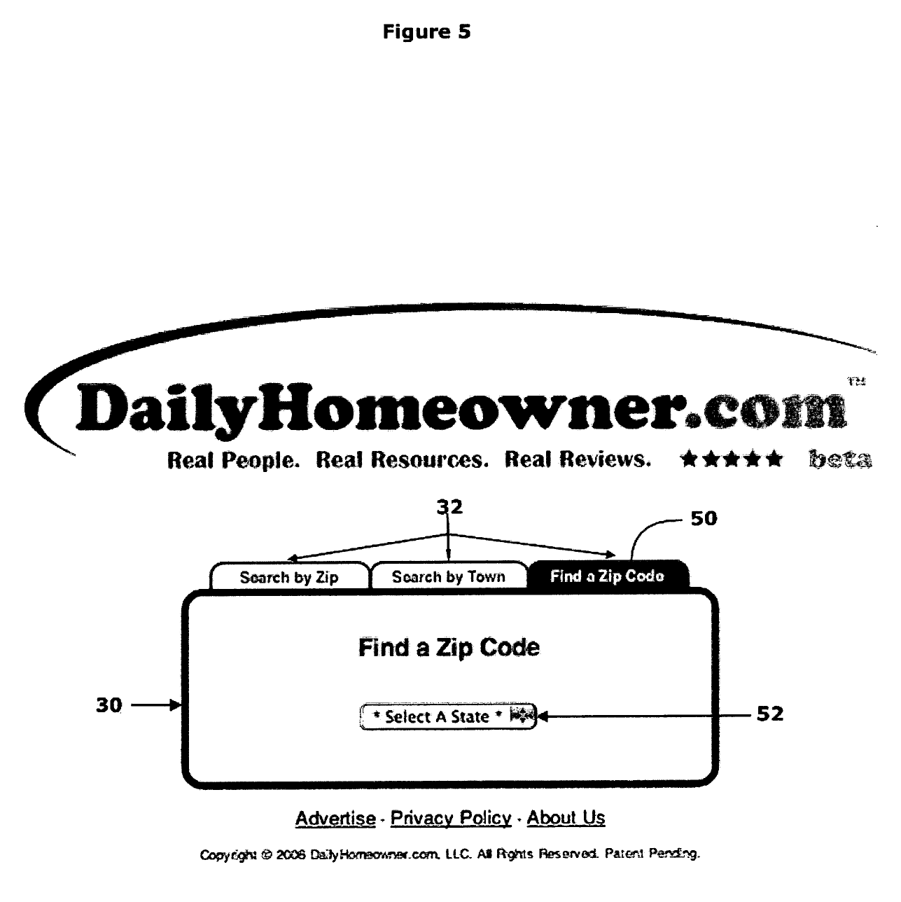

Referring to FIG. 5, a user can also select a “Find a Zip Code” tab 50 to find a zip code corresponding to a location by simply selecting a state using a state selector 52, which can be a drop down menu which displays a list of selectable states. Once a state has been selected using the state selector 52, a list of towns within the selected state is displayed along with their corresponding zip codes. A user can then select a town and/or corresponding zip code, which promptly results in the appearance of a second page having move-in and move-out information, and/or local vendor information.

Alternatively, the “Find a Zip Code” tab 50 can present an interactive country map which the user may use to select a state of interest by clicking on the state. Once the state of interest is selected from the interactive country map, an interactive state map is then displayed. The user than clicks on the town of interest, which then results in a second web page appearing which presents the corresponding local move-in and move-out information, as well as local vendor information.

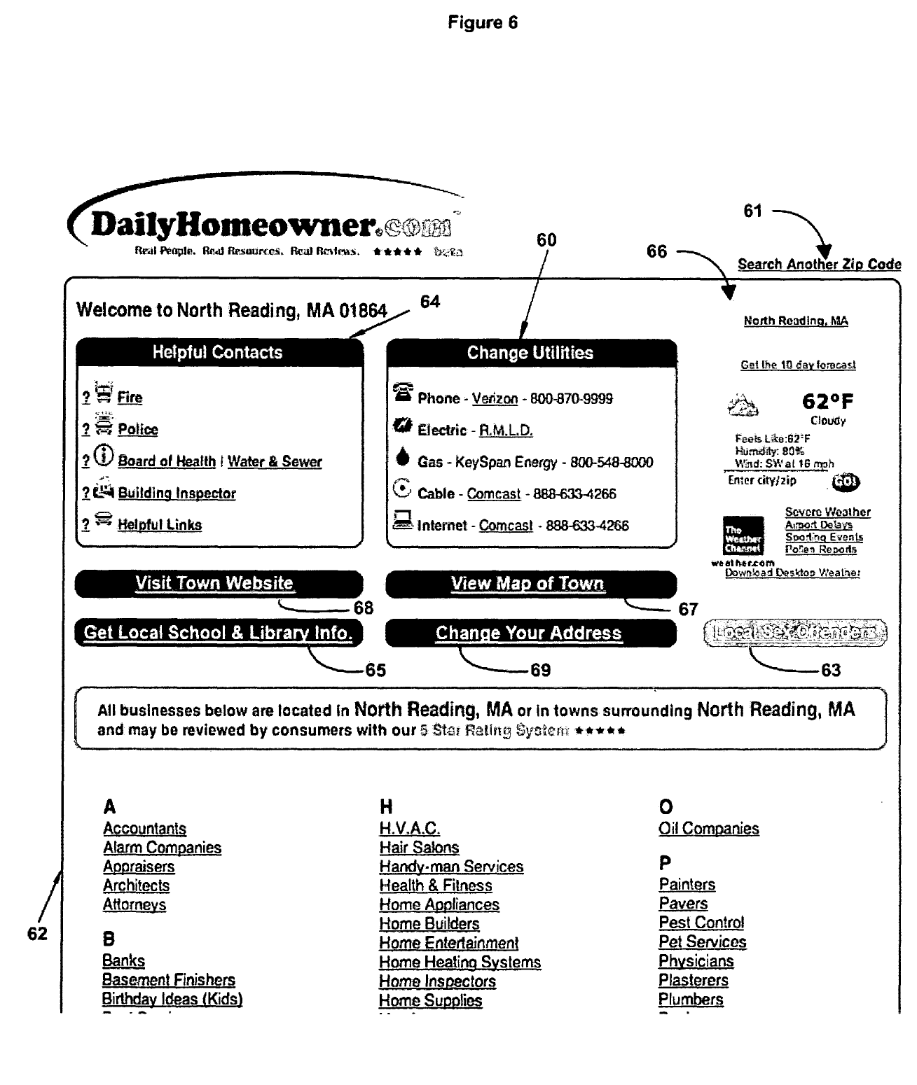

Referring to FIG. 6, after the user has entered particular location information in the location input module 30, that location information is used to look up and populate a second web page with corresponding local home and community information 63-68, local move-in and move-out information 60, as well as local vendor information within vendor category module 62. The local vendor information within vendor category module 62 need not be displayed on the same webpage as the Home and local community information 63-68, move-in and move-out information 60, although they are shown together on the same web page as a preferred embodiment in FIG. 6. If the user wants to look up local home and community information, move-in and move-out information, or local vendor information for another location, they may simply submit new location information by clicking on “search another zip code” hyperlink 61.

Move-in and move-out information 60 includes contact information for utility companies that service the location submitted in the location input module 30, and can take the form of phone numbers, postal addresses, web pages, email addresses, and/or hyperlinks to the utilities' homepages. Move-in and move-out information 60 can be categorized by type of utility, and can advantageously display a specific icon to help the user to identify the category of move-in or move-out information 60 provided alongside the specific icon.

In addition to the move-in and move-out information 60 provided in response to the location information entered into the homepage of the invention, local home and community information 63-68 can also be displayed therewith. Such information can be useful to a buyer or seller, and can be useful to a real estate professional to help facilitate a home sale or purchase. Examples of such other local home and community information can include contact information of and/or links to the homepages of the Fire Department, Police Department, Center for Poison Control, Board of Health, Town Hall, Water and Sewer Departments, Building Inspectors, Registry of Deeds, Assessors Office, and other local links displayed within a “helpful contacts” module 64. There may also be links to the town's website 68, a town map 67, local sex offender registries 63, school and library information 65, and other useful local sites for the future, present, or past homeowner. Such information can also be used by real estate professionals to facilitate a home purchase or sale. A local weather module 66 may display local weather information, and a “Change Your Address” link may also be provided for helping an individual change their postal address 69.

The home and community information displayed in response to the submitted location information can vary in accordance with the requirements of each location or state. For example, in a location where homes typically have their own septic systems or wells, future homeowners may need to contact the board of health to ensure that a septic system was installed correctly, or to verify the quality and quantity of well water. Thus, contact information relating to the board of health is provided within “helpful contacts” module 64 as an important resource for individuals looking to buy and own a home in this local area. Likewise, contact information for the fire department can be displayed within “helpful contacts” module 64 in locations where a seller is required to present a fire department inspection certificate demonstrating functional smoke and CO² detectors upon sale of the home. Conversely, in certain locations where homes utilize public water and sewer or where smoke detector inspection certificates are not required for home sales, the contact information for the board of health or the fire department may not be provided within the “helpful contacts” module 64 but may be provided elsewhere on the same webpage or not at all.

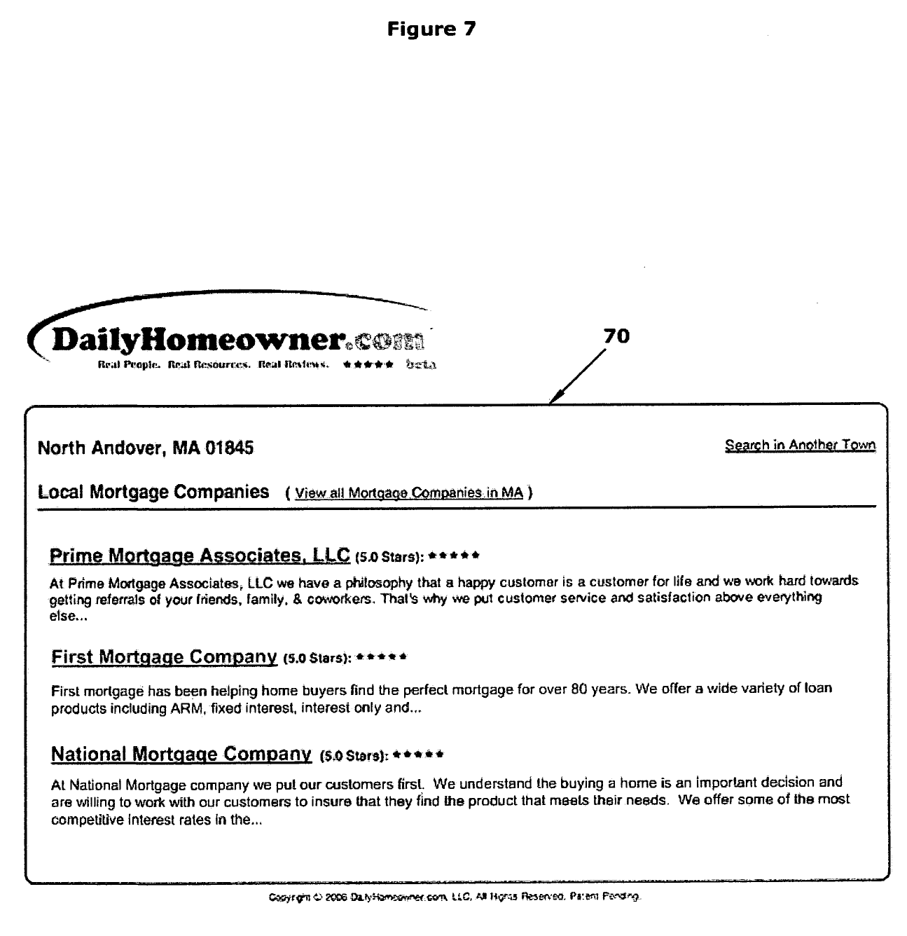

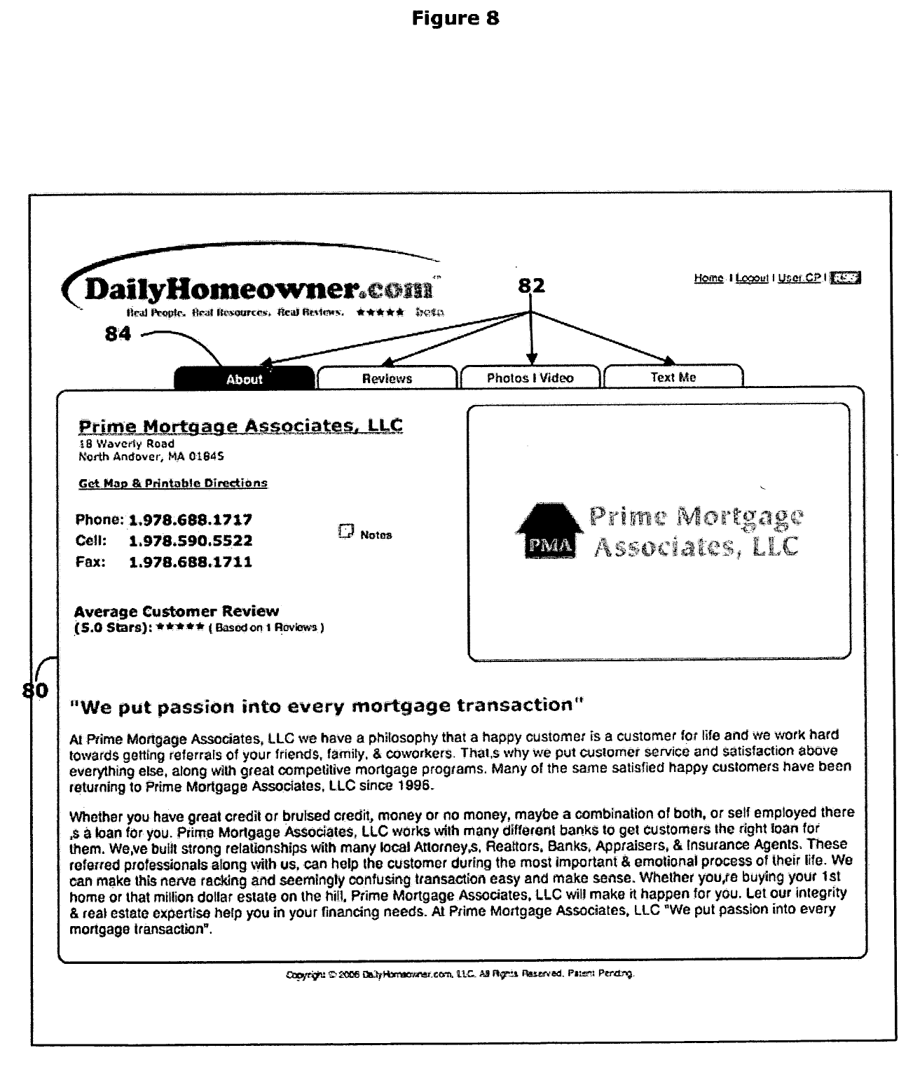

Vendor information corresponding to the submitted location information is displayed in vendor category module 62. Vendor categories are displayed as an alphabetized list to enable a user to easily find vendors associated with specific products or services targeted at homeowners. To reduce clutter within the vendor category module 62, each category is listed as a hyperlink to another web page that contains categorized vendor listings module 70 which displays a list of vendors within the category, as shown in FIG. 7. Each vendor displayed within categorized vendor listings module 70 is described briefly. Each vendor is also listed as a hyperlink to a more specific vendor page. A specific vendor page is shown in FIG. 8, and is explained further below.

Referring again to FIG. 6, a number (not shown) can be displayed next to each hyperlink to inform the user how many vendors are associated with any one category before clicking the hyperlink. Alternatively, the vendor information displayed in the vendor category module 62 can also be presented without any categories, just listing vendors alphabetically by vendor name. Vendor information can be associated with each vendor directly on the page, and can include vendor profile information, a description of the vendor's products and services, ratings and reviews of the vendor's products and/or services by actual customers, photo and video presentations by the vendor or any other information that would be helpful to a prospective customer. All vendor information presented in vendor module 62 is only for local vendors that are located in or adjacent to the region specified by the location information. A homeowner, however, may be provided the option of also viewing all vendors within an entire metropolitan area or an entire state.

Referring again to FIG. 6, a user must click on a hyperlink to obtain a list of local vendors in a selected category. Clicking on the hyperlink will take the user to another web page that displays a list of vendors within the selected category, as shown in FIG. 7. FIG. 7 shows categorized vendor listings module 70, which displays names of the vendors within the selected category, along with a brief vendor description, a vendor rating (.e.g., using a “Five Star” rating system), and a hyperlink. Clicking on the hyperlink takes the user to a web page having a local vendor module 80, as shown in FIG. 8. Alternatively, clicking on the hyperlink can take the user to the vendor's own homepage.

Categorized vendor listings module 70 can also provide the user with the option of viewing all vendors of a specific category within an entire region or state. If this option is chosen by the user, regional and/or state-wide vendor information is displayed in categorized vendor listings module 70. The type and manner of information displayed may be very similar to the type and manner of local vendor information displayed as discussed previously.

Referring again to FIG. 8, to further enhance the ease of use of local vendor module 80, local vendor tabs 82 are included which allow a user to easily toggle among the local vendor tabs 82 so as to quickly and simply find information about the specific vendor featured in local vendor module 80.

The “About” tab 84 displays an assortment of vendor information associated with the vendor featured in local vendor module 80. This information can include a description of the vendor, a map and/or hyperlinks to a mapping and directions website, contact info such as phone/fax/cell numbers, postal address, email address, a link to the vendors webpage, pictures or video of the vendor or their business, and the vendor's star rating. The “About” tab 84 may also provide the homeowner with a notepad to write notes about the vendor.

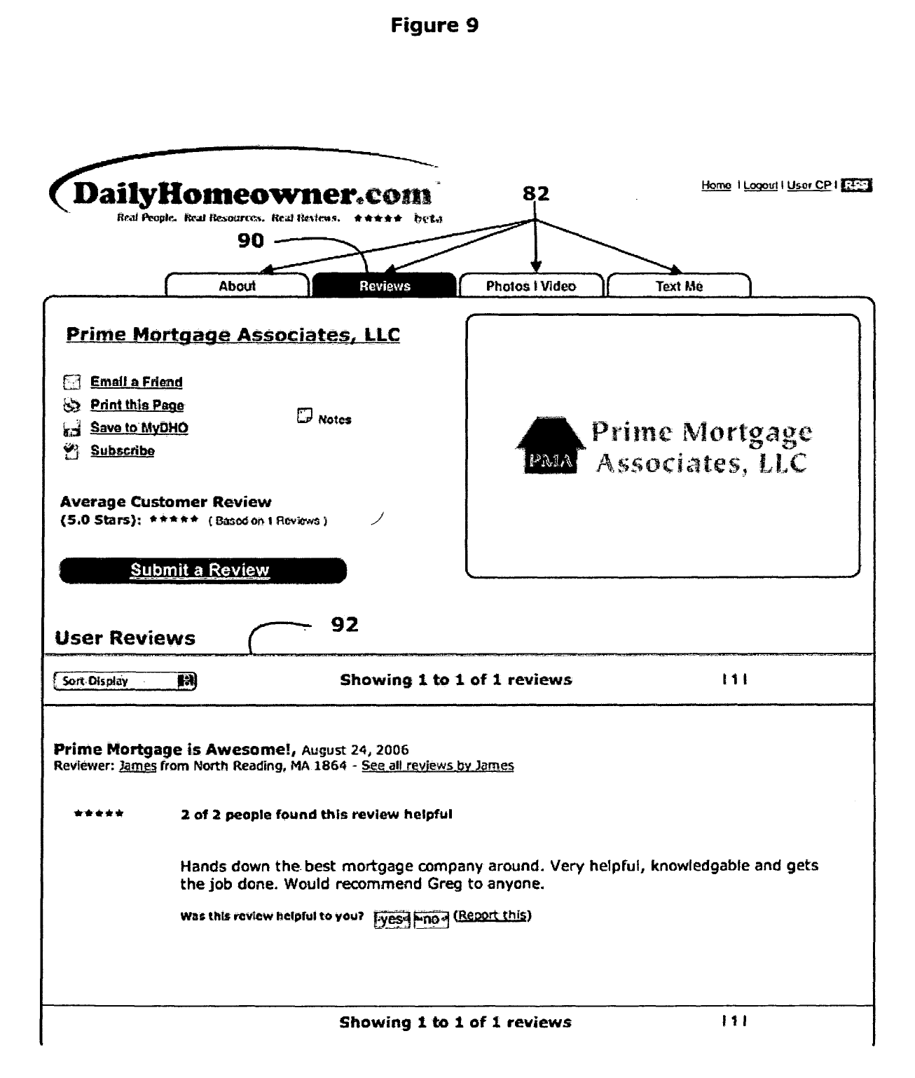

Referring to FIG. 9, local vendor module 80 also includes a “Reviews” tab 90. The “Reviews” tab 90 provides real ratings and reviews of the vendor written by actual customers. Such ratings and reviews are especially important to homeowners that have just purchased a home in a new area, and consequently do not know the reputations of the local vendors. By viewing vendor ratings and reading vendor reviews written by real customers, homeowners can avoid using vendors selling products or services which are either too costly, of poor quality, or who have a reputation for untrustworthiness.

A homeowner using the “Reviews” tab 90 can also submit a review or give a vendor a rating based on their experience with the vendor. A homeowner can also email the vendor's link to a friend, print the vendor information, or save the vendor to their control panel to view later while in vendor “Reviews” tab 90. Vendor “Reviews” tab 90 can also contain a subscribe feature that allows a homeowner to receive notification of, and the opportunity to read or view, any new reviews or ratings of the particular vendor. If a negative review is posted, the vendor to whom the review applies will have the opportunity to respond by posting its response along side the negative review.

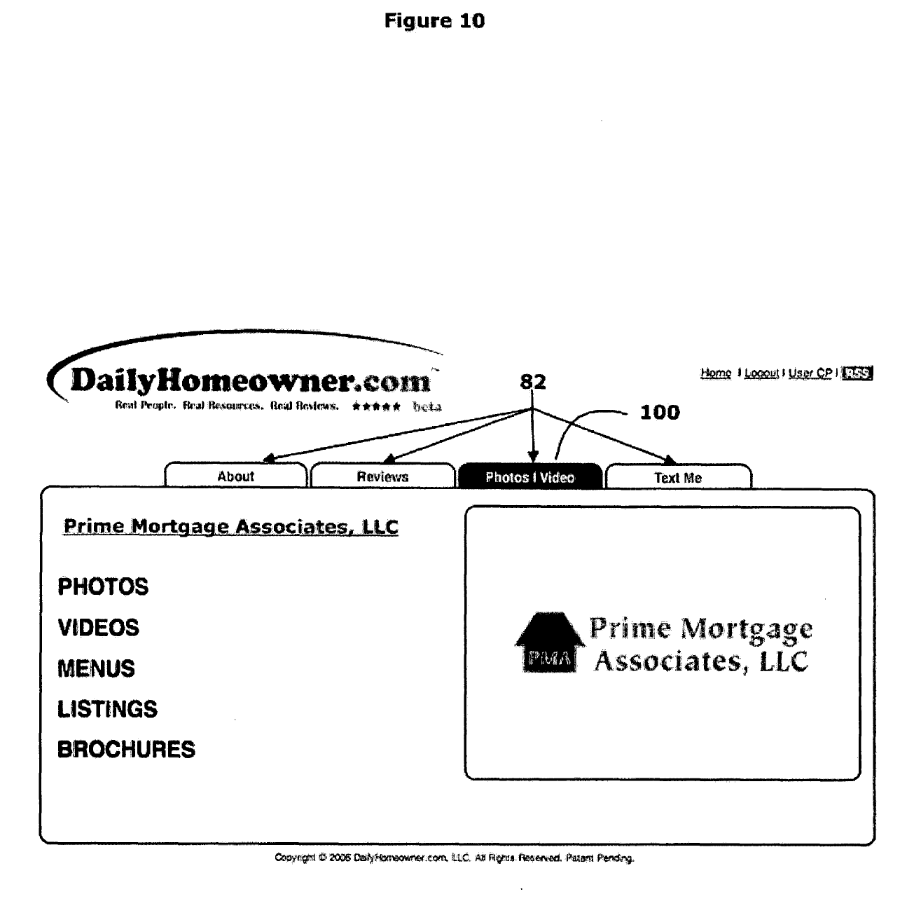

Referring to FIG. 10, the local vendor module 80 also includes a vendor “Photos/Video” tab 100. The “Photos/Video” tab 100 gives a homeowner the chance to view photos and/or videos about themselves or their products and services. The vendor can choose to also post notification of upcoming sales events, a weekly advertisement, a menu, or any other information that may attract new customers. The “Photos/Video” tab 100 can also contain links to photos, videos, menus, real estate listings, or brochures that may be displayed on the same or a different web page.

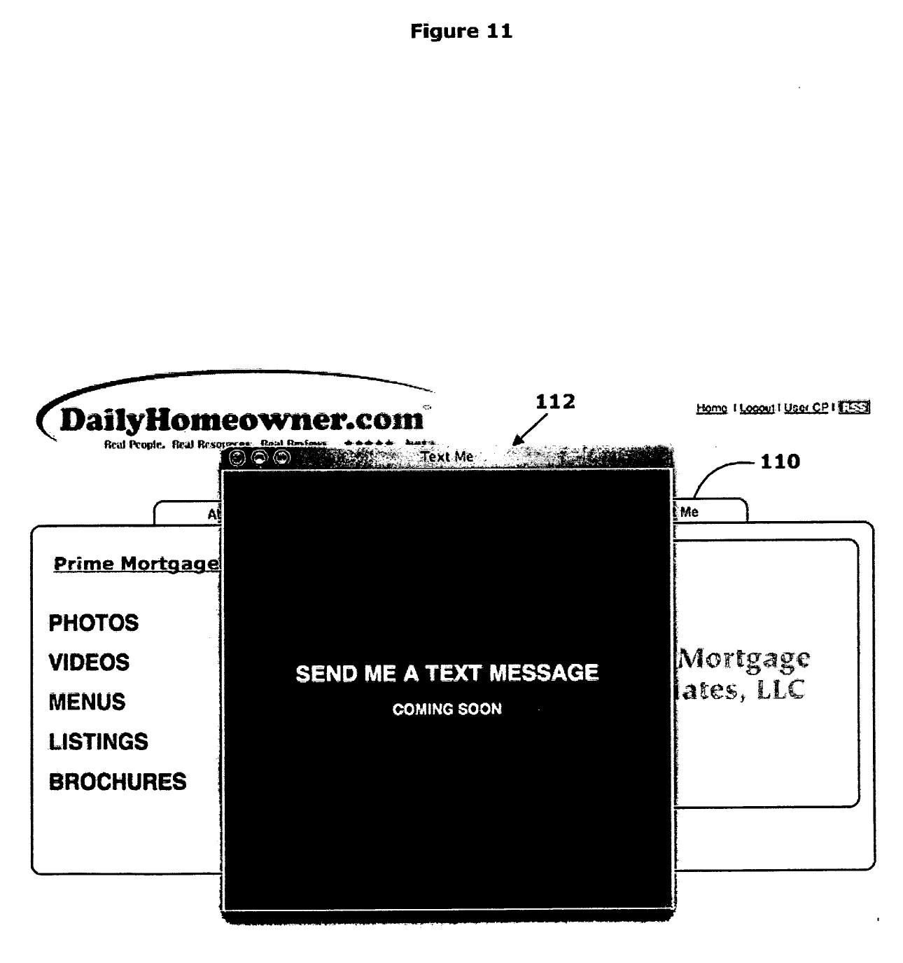

With reference to FIG. 11, the local vendor module 80 also includes a “Text Me” tab 110 which generates a Text Me window 112. Text me window 112 can have fields labeled USER NAME, USER CELL NUMBER, and MESSAGE, for example. This feature allows a user to send a personal text message directly to a vendor's cell phone or email address.

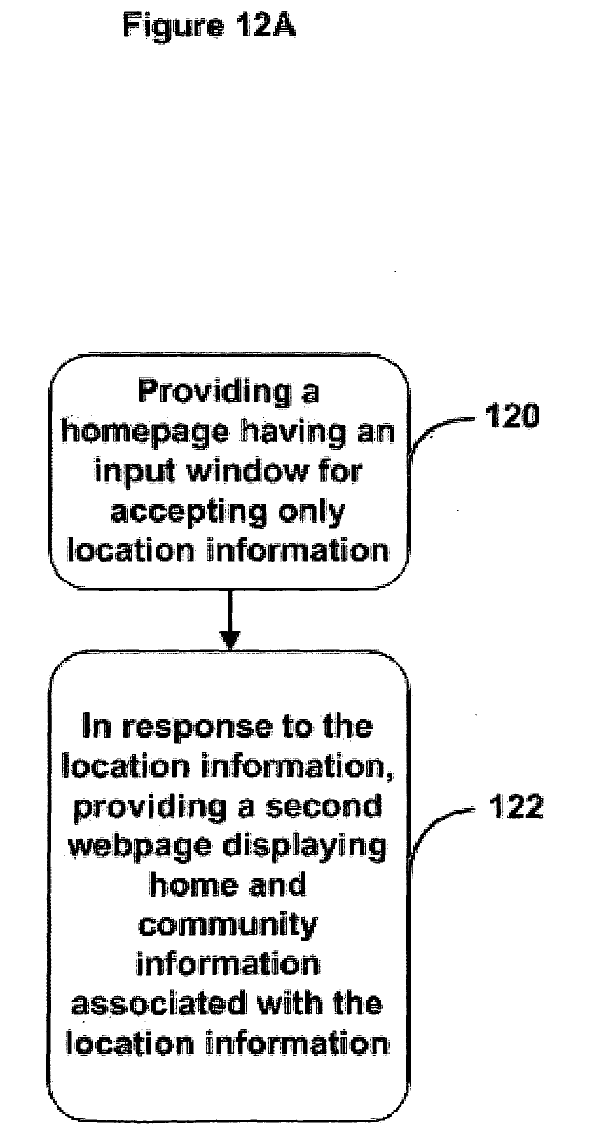

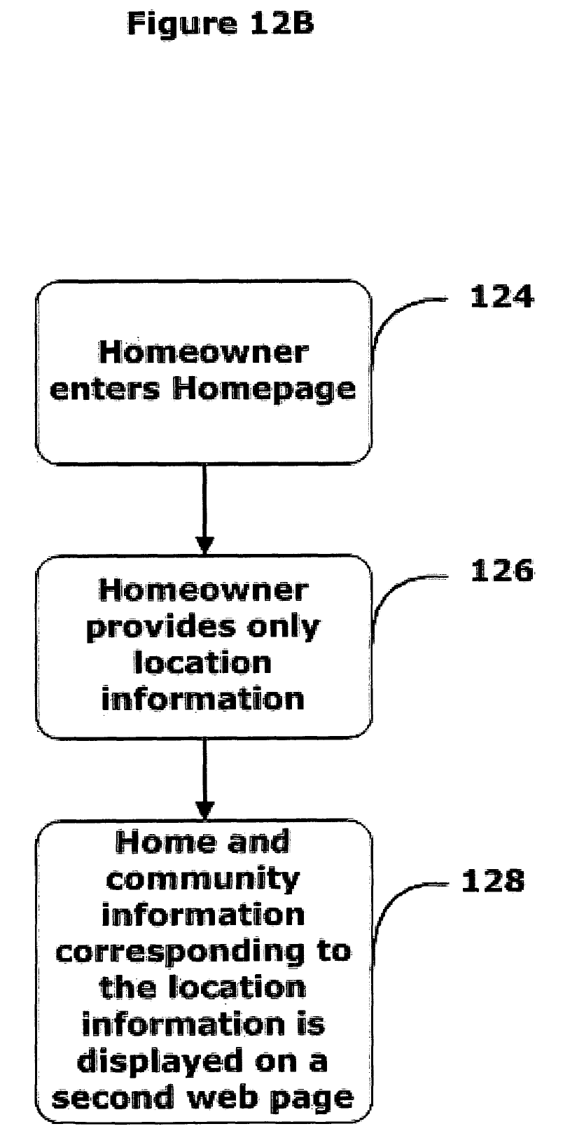

With reference to FIG. 12A, the invention enables a user to easily access home and community information over the internet to facilitate the decision and completion of a home sale or purchase. The invention provides a homepage having an input window for accepting only location information 120. In response to the location information, the invention provides a second web page displaying home and community information that is associated with the location information 122. The home and community information can include contact information of and/or hyperlinks to the homepages of the fire department, police department, center for poison control, board of health, water and sewer departments, town hall, building inspectors and other helpful links. There may also be hyperlinks (e.g., as shown in FIG. ) to the town's website, a town map, local sex offender registries, school and library information, and other helpful sites and information for a future, present, or past homeowner that may help facilitate a home purchase or sale.

With reference to FIG. 12B, a user enters website 124 by using their web browser to visit a URL associated with the website, such as www.dailyhomeowner.com. Upon entering the website, the user can submit only location information 126 because the homepage of the website does not allow or require any other information. During this step 126, the homeowner can enter the location information as a zip code, or as a state and one of a town and a city. Alternatively, the user can look up a zip code by selecting a state and then a town, which consequently provides zip codes associated with the town.

While this site can be used by future, current or previous homeowners, it can also be useful to renters who are moving into or moving out of a home or apartment. It is also useful to homeowners while they are living in the home. Likewise the invention can be very useful for individuals in construction-related trades like builders, plumbers, electricians, or others who would need easy access to home and community information for business purposes. Such purposes may include getting permits and scheduling inspections. Importantly, the conveniently accessible local information is very useful to Realtors, seller's agents, buyer's agents, and many other real estate professionals.

Other modifications and implementations will occur to those skilled in the art without departing from the spirit and the scope of the invention as claimed. Accordingly, the above description is not intended to limit the invention except as indicated in the following claims.

What is claimed is:

1. A method for facilitating access to local move-in information and move-out information by real estate professionals and homeowners, the method comprising:
providing an internet-accessible website having a home webpage and a second webpage;
requesting only location information on the home webpage; and
displaying on the second webpage move-in and move-out information which is specific to the location information.

2. The method of claim 1, wherein the location information is a zip code.

3. The method of claim 1, wherein the location information is a town and a state.

4. The method of claim 1, wherein the move-in and move-out information includes at least one of a phone number and a website address of a local utility.

5. The method of claim 1, wherein the move-in and move-out information includes at least one of a phone number and a website address of each of a plurality of local utilities.

6. The method of claim 5, wherein the move-in and move-out information of the plurality of local utilities is grouped together on a first portion of the second webpage.

7. The method of claim 1, further including:
displaying on the second webpage helpful contact information which is specific to the location information, the helpful contact information including contact information for at least one of: Fire, Police, Board of Health, Building Inspector, Registry of Deeds, Assessors Office.

8. The method of claim 7, wherein the helpful contact information is grouped together on a second portion of the second webpage.

9. The method of claim 1, further including:
displaying on the second webpage a list of vendor categories, each vendor category being associated with a link to at least one vendor in the vendor category, the at least one vendor being associated with the location information.

10. The method of claim 9, wherein the at least one vendor is assigned a rating.

11. A web-based user interface for facilitating access to move-in and move-out information by real estate professionals and homeowners, the user interface including:
a location input module on a home page of a website, the location input module allowing a user to submit only location information on the home page; and
a move-in and move-out information display module on a second page of the website, the information display module displaying move-in information and move-out information which is associated with the location information.

12. The web-based user interface of claim 11, wherein the location information is a zip code.

13. The web-based user interface of claim 11, wherein the location information is a town and a state.

14. The web-based user interface of claim 11, further including:
a vendor information display module on the second page of the website, the vendor information display module displaying a list of vendor categories, each vendor category being associated with a link to at least one vendor in the vendor category, the at least one vendor being associated with the location information.

15. A web-based user,interface for facilitating access to vendor information by real estate professionals and homeowners, the user interface including:
a location input module on a home page of a website, the location input module allowing a user to submit only location information on the home page; and
a vendor information display module on a second page of the website, the information display module displaying vendor information which is associated with the location information.

16. The web-based user interface of claim 15, further including:
home and community information specific to the location information.

17. A method for facilitating access to local vendor information by real estate professionals and homeowners, the method comprising:
providing an internet-accessible website having a home webpage and a second webpage;
requesting only location information on the home webpage; and
displaying on the second webpage links to vendor information which is specific to the location information.

18. The method of claim 17, wherein the links to vendor information are grouped together on a first portion of the second webpage.

19. The method of claim 17, wherein each link to vendor information is associated with a vendor category.

20. The method of claim 17, wherein the links to vendor information includes links to vendor rating information.
